(19) United States
(12) Patent Application Publication
(10) Pub. No.: US 2026/0186960 A1
(43) Pub. Date: Jul. 2, 2026

(54) INFORMATION PROCESSING SYSTEM, INFORMATION PROCESSING METHOD, AND NON-TRANSITORY COMPUTER READABLE MEDIUM

(71) Applicant: FUJIFILM Business Innovation Corp., Tokyo (JP)

(72) Inventors: Hidenori TANAKA, Kanagawa (JP); Hirohito OTAKE, Kanagawa (JP)

(73) Assignee: FUJIFILM Business Innovation Corp., Tokyo (JP)

(21) Appl. No.: 19/196,075

(22) Filed: May 1, 2025

(30) Foreign Application Priority Data
Dec. 26, 2024 (JP) 2024-230834

(51) Int. Cl. G06F 12/02

(52) U.S. Cl. CPC G06F 12/0246

(57) ABSTRACT

An information processing system includes a memory having a memory capacity less than a necessary memory capacity that is required to execute multiple functions without switching between memory maps, and a processor configured to accumulate usage histories of the multiple functions for each user, and when a user logs in, perform processing for switching between the memory maps, based on usage histories of the logged-in user.

### CROSS-REFERENCE TO RELATED APPLICATIONS

This application is based on and claims priority under 35 USC 119 from Japanese Patent Application No. 2024-230834 filed Dec. 26, 2024.

### BACKGROUND

### (i) Technical Field

The present disclosure relates to an information processing system, an information processing method, and a non-transitory computer readable medium.

### (ii) Related Art

In Japanese Unexamined Patent Application Publication No. 2010-211696, a memory swap management method that, in an information processing apparatus that executes a job including at least one process, carries out virtual storage of the process using a first storage device and a second storage device, is disclosed. The memory swap management method includes a storing step of storing a planned execution sequence of jobs in the case where there are a plurality of jobs waiting to be executed in the information processing apparatus, a determining step of determining a process as a swap-out candidate and a process as a swap-in candidate, based on the planned execution sequence of the jobs waiting to be executed stored in the storing step and types of processes stored in the first storage device, and a swap processing step of, based on the determination in the determining step, swapping out the process as the swap-out candidate from the first storage device to the second storage device and swapping in the process as the swap-in candidate from the second storage device into a region of the first storage device freed as a result of the swap-out.

In Japanese Unexamined Patent Application Publication No. 2015-162760, an image processing apparatus including a reconfigurable circuit in which part of a circuit arrangement is dynamically reconfigurable is disclosed. The image processing apparatus includes status determining means for determining a status when the image processing apparatus is activated, first reconfiguring means for reconfiguring a circuit arrangement for executing a job that is highly likely to be instructed from a circuit arrangement that has already been configured on the reconfigurable circuit, based on the status determined by the status determining means, accepting means for accepting a job, second reconfiguring means for reconfiguring, if the job accepted by the accepting means is not executable by the circuit arrangement configured on the reconfigurable circuit, a circuit arrangement that is needed for execution of the job on the reconfigurable circuit, and executing means for executing the job accepted by the accepting means.

In Japanese Unexamined Patent Application Publication No. 2010-003076, an image processing apparatus that has a plurality of types of functions and is capable of executing a job relating to any of the plurality of types of functions is disclosed. The image processing apparatus includes program executing means capable of executing a program that causes the image processing apparatus to execute the job, memory managing means for securing a storage region for the program executing means to execute the program in a first storage device, saving means for saving information stored in the storage region secured in the first storage device by the memory managing means to a second storage device, history recording means for recording a history relating to execution of the job every time the image processing apparatus executes the job, and save restricting means for preventing the storage region secured in the first storage device by the memory managing means for execution of the job relating to a function identified based on the history of the job recorded by the history recording means out of the plurality of types of functions from being saved to the second storage device.

### SUMMARY

In an information processing system such as a multifunction machine capable of executing a plurality of functions such as copy, scan, and facsimile, in the case where a memory has a sufficient memory capacity, the information processing system is able to execute the plurality of functions without switching between memory maps.

However, if the memory capacity is not sufficient enough to be able to execute the plurality of functions without switching between the memory maps, switching to a memory map for a function desired to be executed is required. There is a problem that the start time of execution of the function is delayed according to the time required for switching to the memory map.

Aspects of non-limiting embodiments of the present disclosure relate to an information processing system, an information processing method, and a non-transitory computer readable medium capable of preventing the start time of execution of a function from being delayed.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a memory having a memory capacity less than a necessary memory capacity that is required to execute a plurality of functions without switching between memory maps, and a processor configured to accumulate usage histories of the plurality of functions for each user, and when a user logs in, perform processing for switching between the memory maps, based on usage histories of the logged-in user.

### BRIEF DESCRIPTION OF THE DRAWINGS

Exemplary embodiments of the present disclosure will be described in detail based on the following figures, wherein:

FIG. 1 is a diagram illustrating an example of the hardware configuration of an information processing system;

FIG. 2 is a diagram illustrating an example of memory maps;

FIG. 3 is a diagram illustrating an example of the functional configuration of the information processing system;

FIG. 4 is a diagram illustrating an example of usage history data; and

FIG. 5 is a flowchart of an information process.

### DETAILED DESCRIPTION

Hereinafter, an exemplary embodiment of the present disclosure will be described with reference to drawings. In the drawings, the same or equivalent component elements and parts are denoted by the same reference signs.

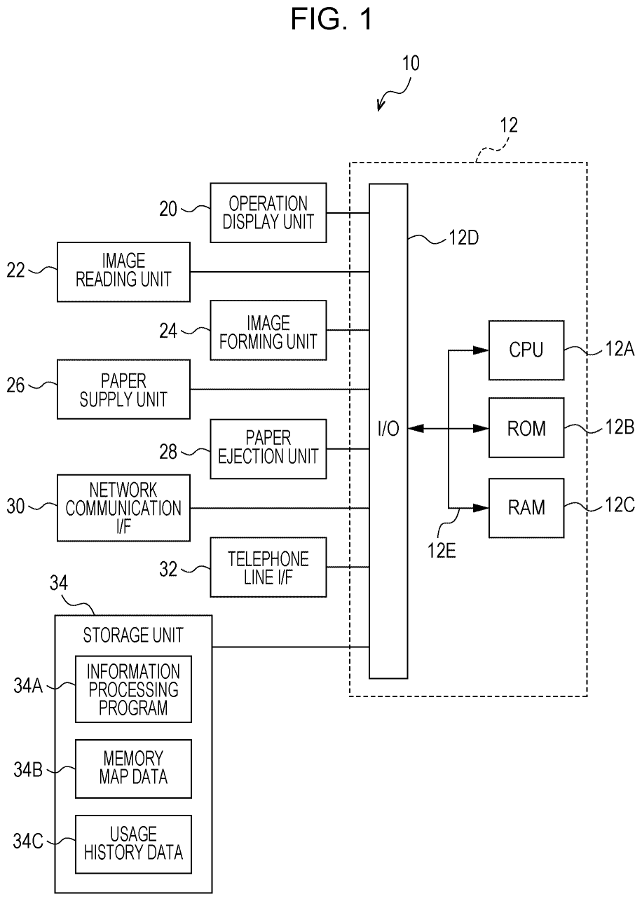

FIG. 1 illustrates a schematic configuration of an information processing system 10. In this exemplary embodiment, an example in which the information processing system 10 is a multifunction machine capable of executing a plurality of functions such as copy, scan, and facsimile will be described. However, the information processing system 10 is not necessarily a multifunction machine.

As illustrated in FIG. 1, the information processing system 10 includes a controller 12. The controller 12 is a device including a typical computer.

The controller 12 includes a central processing unit (CPU) 12A, a read only memory (ROM) 12B, a random access memory (RAM) 12C, and an input/output interface (I/O) 12D. The CPU 12A, the ROM 12B, the RAM 12C, and the I/O 12D are connected to one another by a bus 12E. The bus 12E includes a control bus, an address bus, and a data bus.

Functional units such as an operation display unit 20, an image reading unit 22, an image forming unit 24, a paper supply unit 26, a paper ejection unit 28, a network communication interface (I/F) 30, a telephone line interface (I/F) 32, and a storage unit 34 are connected to the I/O 12D.

The operation display unit 20 includes, for example, various buttons such as a start button for instructing to start copying or other processing and numeric keys, a touch panel for displaying a setting screen for setting various image forming conditions including copy density and various screens indicating, for example, the state of the apparatus, and so on.

The image reading unit 22 includes an image reading sensor such as a line charge-coupled device (CCD), a scanning mechanism for scanning with the image reading sensor, and so on and reads an image of a document set on the apparatus.

The image forming unit 24 forms an image on a recording medium by, for example, a so-called electrophotographic system. Specifically, the image forming unit 24 includes a charging device for charging a photoconductor drum, an exposure device that forms an electrostatic latent image corresponding to an image on the photoconductor drum by causing the charged photoconductor drum to be exposed to light corresponding to the image, a developing device that develops with toner the electrostatic latent image formed on the photoconductor drum, a transfer device that transfers a toner image corresponding to the image formed on the photoconductor drum, a fixing device that fixes the toner image corresponding to the image transferred to the recording medium, and so on.

The exposure device is, for example, an optical scanning device that includes an optical system including a semiconductor laser, a rotating polygon mirror, a collimator lens, a cylindrical lens, an fθ lens, and so on, a light-emitting diode (LED) head including a plurality of LEDs, or the like.

The paper supply unit 26 includes a paper tray in which recording paper is accommodated, a supply mechanism that supplies the recording paper from the paper tray to the image forming unit 24, and so on.

The paper ejection unit 28 includes an ejection tray from which the recording paper is ejected, an ejection mechanism for ejecting the recording paper on which an image is formed by the image forming unit 24 to the ejection tray, and so on.

The network communication I/F 30 is an interface that allows data communication with an external apparatus via a network.

The telephone line communication I/F 32 is an interface that allows facsimile communication with another apparatus connected by a telephone line, which is not illustrated in FIG. 1.

The storage unit 34 includes a nonvolatile external storage device such as a hard disk or a solid state drive (SSD).

For example, log data such as the state of each unit of the apparatus and an operating status, log data of processing results of functions such as copy, scan, facsimile communication, and print, various setting data, an information processing program 34A, memory map data 34B, usage history data 34C, and so on are stored in the storage unit 34.

The RAM 12C is an example of a memory. The RAM 12C has a memory capacity less than a necessary memory capacity that is required to execute a plurality of functions without switching between memory maps. The plurality of functions are functions provided by the information processing system 10 to a user and include functions such as copy, scan and facsimile. A memory map is data in which usage areas for individual purposes when functions are executed are allocated.

In the case where a multifunction machine includes a memory having a memory capacity equal to or more than a necessary memory capacity that is required to execute a plurality of functions without switching between memory maps, the multifunction machine does not need to perform switching between the memory maps to execute each function. However, in the case where a multifunction machine includes a memory having a memory capacity less than the necessary memory capacity that is required to execute a plurality of functions without switching between memory maps, the multifunction machine needs to perform switching between the memory maps before executing a function.

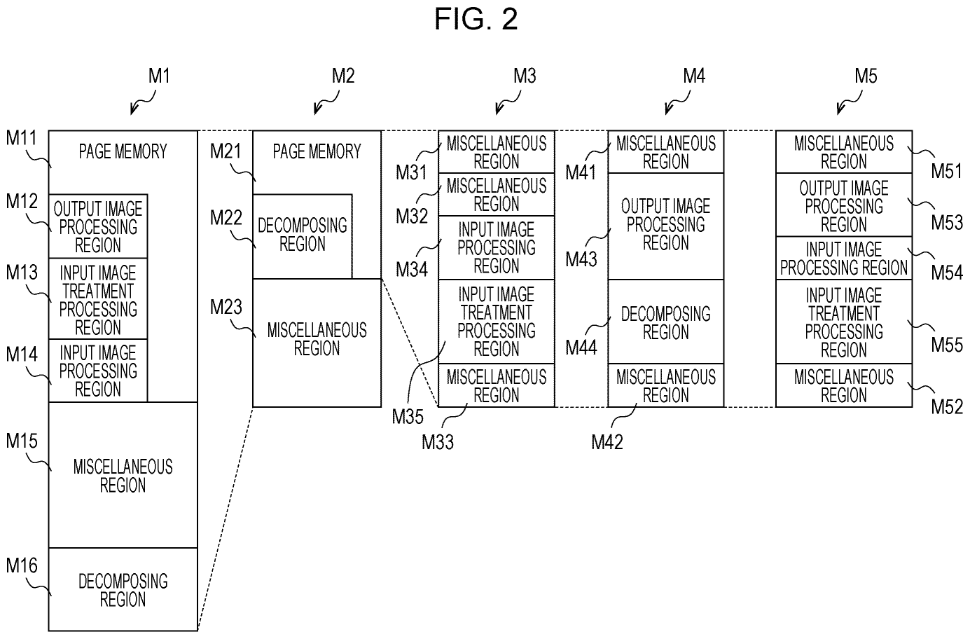

FIG. 2 illustrates a memory map M1 for a memory having, for example, a memory capacity (for example, 4 gigabytes) that is equal to or more than the necessary capacity.

The memory map M1 illustrated in FIG. 2 is a memory map in which a page memory M11, an output image processing region M12, an input image treatment processing region M13, an input image processing region M14, a miscellaneous region M15, and a decomposing region M16 are allocated. In the case of the memory map M1 arranged as described above, switching between memory maps is not required to execute any of copy, scan, facsimile communication, print, and other functions.

In contrast, a memory map M2 illustrated in FIG. 2 is a memory map that is applied to a memory with a memory capacity (for example, 2 gigabytes) that is half the capacity of the memory to which the memory map M1 is applied.

As illustrated in FIG. 2, the memory map M2 is a memory map in which a page memory M21, a decomposing region M22, and a miscellaneous region M23 are allocated.

In the case of the memory map M2 arranged as described above, every time a function is executed, for example, the page memory M21 and the decomposing region M22 need to be switched to a memory map corresponding to the function to be executed.

In FIG. 2, a memory map M3 for the case where a function to be executed is scan or facsimile communication, a memory map M4 for the case where a function to be executed is print, and a memory map M5 for the case where a function to be executed is copy are illustrated.

As illustrated in FIG. 2, the memory map M3 for the case where the function to be executed is scan or facsimile communication is a memory map in which miscellaneous regions M31, M32, and M33, an input image processing region M34, and an input image treatment processing region M35 are allocated.

Furthermore, the memory map M4 for the case where the function to be executed is print is a memory map in which miscellaneous regions M41 and M42, an output image processing region M43, and a decomposing region M44 are allocated.

Furthermore, the memory map M5 for the case where the function to be executed is copy is a memory map in which miscellaneous regions M51 and M52, an output image processing region M53, an input image processing region M54, and an input image treatment processing region M55 are allocated.

The memory map data 34B includes the memory maps M2, M3, M4, and M5.

In the case where the RAM 12C has a memory capacity to which the memory map M2 illustrated in FIG. 2 is applied, switching to a memory map corresponding to a function to be executed needs to be performed. In multifunction machines, a first copy output time (FCOT) performance, that is, minimizing as much as possible the time from setting of a document by a user to pressing of the start button and ejection of the first sheet of printing paper, is prioritized. Therefore, at the startup of the multifunction machine and recovery from a power-saving state, the memory map M5 for copy is normally set. In this case, if a function that the user wishes to execute is print, scan, or facsimile communication, it takes time to perform switching from the memory map M5 to the memory map M3 or the memory map M4 arises, which causes the start time of execution of the function to be delayed.

Thus, the information processing system 10 according to this exemplary embodiment accumulates usage histories of a plurality of functions for each user. When a user logs into the information processing system 10, the information processing system 10 performs, based on the usage histories of the user who has logged in, processing for switching between memory maps.

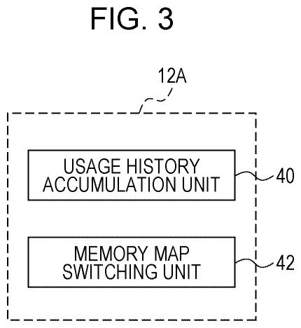

FIG. 3 illustrates an example of the functional configuration of the information processing system 10.

The information processing system 10, functionally, includes a usage history accumulation unit 40 and a memory map switching unit 42. These functional configurations are implemented when the CPU 12A reads the information processing program 34A from the storage unit 34, loads the information processing program 34A onto the RAM 12C, and executes the information processing program 34A.

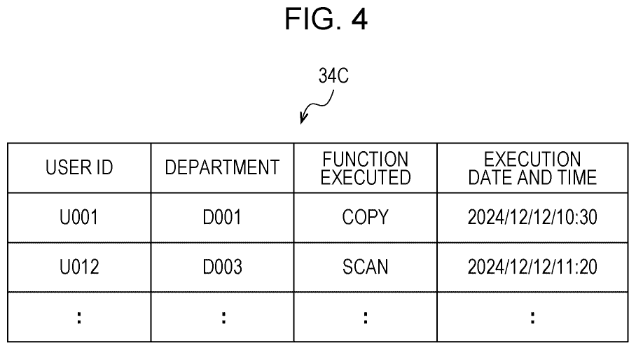

The usage history accumulation unit 40 accumulates, for each user, usage histories of a plurality of functions. Specifically, every time a user logs into the information processing system 10 and executes a function, the usage history accumulation unit 40 stores a usage history as the usage history data 34C into the storage unit 34. FIG. 4 illustrates an example of the usage history data 34C. An example in which the information processing system 10 is a multifunction machine used within a company will be described.

As illustrated in FIG. 4, the usage history data 34C is data in which a user ID of a user who has logged in, department code of a department to which the user who has logged in belongs, a function executed, and the date and time when the function was executed are accumulated. By referencing the usage history data 34C, information on a user, a department to which the user belongs, a function the user executed, and the date and time when the user executed the function is obtained.

When a user logs in, the memory map switching unit 42 performs processing for switching between memory maps, based on usage histories of the logged-in user. The processing for switching between memory maps is, in other words, processing for overwriting the currently set memory map with a memory map to be switched.

Specifically, when the user logs in, the memory map switching unit 42 performs processing for switching between the memory maps, based on usage histories of the logged-in user, without waiting for receiving an instruction to start executing a function.

For example, the memory map switching unit 42 performs processing for switching to a memory map corresponding to the function that was used most frequently by the logged-in user during a predetermined past period of time. The predetermined past period of time may be any length of time, for example, one week, one month, or the like.

Specifically, the memory map switching unit 42 references the usage history data 34C. In the case where the function that was used most frequently by the logged-in user during the predetermined past period of time is scan, the memory map switching unit 42 performs processing for switching to the memory map M3. Thus, compared to the case where a user logs in, sets a document, and presses the start button so that scanning will start and switching to the memory map M3 is then performed, the start time of execution of scanning is prevented from being delayed.

Furthermore, the memory map switching unit 42 may perform processing for switching to a memory map corresponding to the function that was used most frequently on the same day of the week as the day of the week on which the user logs in.

Specifically, the memory map switching unit 42 references the usage history data 34C to identify execution dates and times when functions were executed on the same day of the week as the day of the week on which the user logs in. In the case where the function that was used most frequently among the functions that were executed on the identified execution dates and times is print, the memory map switching unit 42 performs processing for switching to the memory map M4.

Furthermore, the memory map switching unit 42 may perform processing for switching to a memory map corresponding to the function that was used most frequently during the same time period as a time period including the time at which the user logs in. The time period may be any length of time, for example, thirty minutes, one hour, or the like.

Specifically, the memory map switching unit 42 references the usage history data 34C to identify execution dates and times when functions were executed during the same time period as a time period including the time at which the user logs in. In the case where the function that was used most frequently among the functions that were executed on the identified execution dates and times is print, the memory map switching unit 42 performs processing for switching to the memory map M4.

Furthermore, the memory map switching unit 42 may perform processing for switching to a memory map corresponding to the function that was used most frequently in a department of an organization to which the logged-in user belongs.

Specifically, the memory map switching unit 42 references the usage history data 34C to identify a department of an organization to which the logged-in user belongs. In the case where the function that was used most frequently in the identified department is print, the memory map switching unit 42 performs processing for switching to the memory map M4.

In the case where a memory map that has already been set when the user logs in is the same as a memory map set based on usage histories, there is no need to perform processing for switching between memory maps.

The memory map switching unit 42 may be configured to perform the processing for switching between the memory maps in the case where a memory map that has already been set when the user logs in and a memory map that is set based on the usage histories are different.

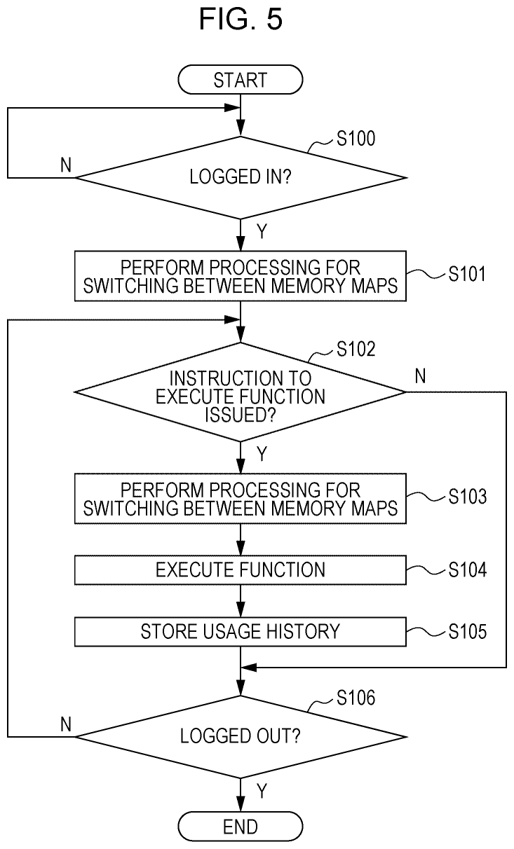

Next, an information process performed by the CPU 12A of the information processing system 10 will be described. FIG. 5 illustrates a flowchart of an information process according to an exemplary embodiment.

In step S100, the CPU 12A determines whether or not a user has logged in. In the case where a user has logged in, the process proceeds to step S101. In contrast, in the case where no user has logged in, the process waits until a user logs in.

In step S101, the CPU 12A performs processing for switching between memory maps. That is, as described above, the CPU 12A performs processing for switching between memory maps, based on usage histories of the user who has logged in. At this time, if the currently set memory map and a memory map set based on the usage histories are the same, the CPU 12A does not perform the processing for switching between the memory maps.

In step S102, the CPU 12A determines whether or not an instruction to execute a function has been issued. In the case where an instruction to execute a function has been issued, the process proceeds to step S103. In the case where an instruction to execute a function has not been issued, the process proceeds to step S105.

In step S103, the CPU 12A performs the processing for switching between the memory maps, as in step S101. However, if it is immediately after the user logged in and the processing for switching between the memory maps has already been performed in step S101, the processing for switching between the memory maps in step S103 is not performed. That is, the processing for switching between the memory maps in step S103 is performed when the process goes through steps S106, S102, and S103 in this order.

In step S104, the CPU 12A executes the function for which the instruction for execution has been issued. That is, in the case where an instruction to execute scan processing has been issued, the CPU 12A executes the scan processing. In the case where an instruction to execute copy processing has been issued, the CPU 12A executes the copy processing. In the case where an instruction to execute print processing has been issued, the CPU 12A performs the print processing.

In step S105, the CPU 12A stores a usage history. That is, as illustrated in FIG. 4, the CPU 12A records into the usage history data 34C a user ID of the user who has logged in, department code of a department to which the logged-in user belongs, a function executed, and the date and time when the function was executed.

In step S106, the CPU 12A determines whether or not the user has logged out. In the case where the user has not logged out, the process proceeds to step S102. In the case where the user has logged out, the current processing routine ends.

As described above, in this exemplary embodiment, in the case where the RAM 12C is a memory having a memory capacity less than a necessary memory capacity that is required to execute a plurality of functions without switching between memory maps, the CPU 12A accumulates usage histories of the plurality of functions for each user. When a user logs in, the CPU 12A performs processing for switching between the memory maps, based on usage histories of the logged-in user. Accordingly, the start time of execution of a function is prevented from being delayed.

In the exemplary embodiments described above, an example in which a program is stored in the storage unit 34 has been described. However, the program is not necessarily stored in the storage unit 34. A program according to an exemplary embodiment of the present disclosure may be recorded in a storage medium readable by the CPU 12A and provided. For example, the program may be recorded in an optical disc such as a compact disk-read only memory (CD-ROM) or a digital versatile disk-read only memory (DVD-ROM) and provided. Furthermore, the program may be recorded in a portable semiconductor memory such as a universal serial bus (USB) memory or a memory card and provided. Furthermore, the program may be recorded in the ROM 12B and provided. The ROM 12B, the storage unit 34, the CD-ROM, the DVD-ROM, the USB memory, and the memory card are examples of a non-transitory storage medium.

Furthermore, the information processing system 10 may download the program from an external apparatus (not illustrated in drawings) via the Internet and store the downloaded program into the storage unit 34. In this case, the CPU 12A of the information processing system 10 may read an information processing program downloaded from the external apparatus and stored in the storage unit 34 and execute various processes.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content. Furthermore, a program according an exemplary embodiment of the present application may be provided as a program product.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An information processing system comprising:
a memory having a memory capacity less than a necessary memory capacity that is required to execute a plurality of functions without switching between memory maps; and
a processor configured to:
accumulate usage histories of the plurality of functions for each user; and
when a user logs in, perform processing for switching between the memory maps, based on usage histories of the logged-in user.
   (((2)))

The information processing system according to (((1))), wherein the processor is configured to perform processing for switching to a memory map corresponding to a function that was used most frequently by the logged-in user during a predetermined past period of time.

(((3)))

The information processing system according to (((1))), wherein the processor is configured to perform processing for switching to a memory map corresponding to a function that was used most frequently on the same day of the week as a day of the week on which the user logs in.

(((4)))

The information processing system according to (((1))), wherein the processor is configured to perform processing for switching to a memory map corresponding to a function that was used most frequently during the same time period as a time period including a time at which the user logs in.

(((5)))

The information processing system according to (((1))), wherein the processor is configured to perform processing for switching to a memory map corresponding to a function that was used most frequently in a department of an organization to which the logged-in user belongs.

(((6)))

The information processing system according to any one of (((1))) to (((5))), wherein the processor is configured to perform the processing for switching between the memory maps in a case where a memory map that has already been set when the user logs in and a memory map that is set based on the usage histories are different.

(((7)))

An information processing program for causing a computer to execute a process comprising:
accumulating usage histories of a plurality of functions for each user; and
when a user logs in, performing, based on usage histories of the logged-in user, processing for switching between memory maps of a memory having a memory capacity less than a necessary memory capacity that is required to execute the plurality of functions without switching between the memory maps.

What is claimed is:

1. An information processing system comprising:
a memory having a memory capacity less than a necessary memory capacity that is required to execute a plurality of functions without switching between memory maps; and
a processor configured to:
accumulate usage histories of the plurality of functions for each user; and
when a user logs in, perform processing for switching between the memory maps, based on usage histories of the logged-in user.

2. The information processing system according to claim 1, wherein the processor is configured to perform processing for switching to a memory map corresponding to a function that was used most frequently by the logged-in user during a predetermined past period of time.

3. The information processing system according to claim 1, wherein the processor is configured to perform processing for switching to a memory map corresponding to a function that was used most frequently on the same day of the week as a day of the week on which the user logs in.

4. The information processing system according to claim 1, wherein the processor is configured to perform processing for switching to a memory map corresponding to a function that was used most frequently during the same time period as a time period including a time at which the user logs in.

5. The information processing system according to claim 1, wherein the processor is configured to perform processing for switching to a memory map corresponding to a function that was used most frequently in a department of an organization to which the logged-in user belongs.

6. The information processing system according to claim 1, wherein the processor is configured to perform the processing for switching between the memory maps in a case where a memory map that has already been set when the user logs in and a memory map that is set based on the usage histories are different.

7. The information processing system according to claim 2, wherein the processor is configured to perform the processing for switching between the memory maps in a case where a memory map that has already been set when the user logs in and a memory map that is set based on the usage histories are different.

8. The information processing system according to claim 3, wherein the processor is configured to perform the processing for switching between the memory maps in a case where a memory map that has already been set when the user logs in and a memory map that is set based on the usage histories are different.

9. The information processing system according to claim 4, wherein the processor is configured to perform the processing for switching between the memory maps in a case where a memory map that has already been set when the user logs in and a memory map that is set based on the usage histories are different.

10. The information processing system according to claim 5, wherein the processor is configured to perform the processing for switching between the memory maps in a case where a memory map that has already been set when the user logs in and a memory map that is set based on the usage histories are different.

11. An information processing method comprising:
accumulating usage histories of a plurality of functions for each user; and
when a user logs in, performing, based on usage histories of the logged-in user, processing for switching between memory maps of a memory having a memory capacity less than a necessary memory capacity that is required to execute the plurality of functions without switching between the memory maps.

12. A non-transitory computer readable medium storing a program causing a computer to execute a process comprising:
accumulating usage histories of a plurality of functions for each user; and
when a user logs in, performing, based on usage histories of the logged-in user, processing for switching between memory maps of a memory having a memory capacity less than a necessary memory capacity that is required to execute the plurality of functions without switching between the memory maps.
